(19) United States
(12) Patent Application Publication
(10) Pub. No.: US 2004/0046642 A1
(43) Pub. Date: Mar. 11, 2004

(54) Protocol for addressing groups of RFID tags

(75) Inventors: Robert C. Becker, Eden Prairie, MN (US); David W. Meyers, Brooklyn Park, MN (US); Sabera Kazi, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/235,437

(22) Filed: Sep. 5, 2002

(51) Int. Cl. H04Q 5/22; H04Q 1/00

(52) U.S. Cl. 340/10.32; 340/825.52

(57) ABSTRACT

A tagging system includes a tag reader and a plurality of RFID tags. The tag reader addresses a group of RFID tags, and the group of RFID tags is a subset of the plurality of RFID tags. Each of the RFID tags in the plurality of RFID tags has a unique identifier. The tag reader transmits a group address having first and second sets of data elements. The data elements in the first set of data elements are substantially equal in value to corresponding ones of the data elements in the identifiers of the group of RFID tags. The data elements in the second set of data elements represent any value for corresponding ones of the data elements in the identifiers of the group of RFID tags. Only the RFID tags having corresponding data elements in their identifiers that match the first set of data elements in the group address respond.

### TECHNICAL FIELD OF THE INVENTION

The present invention relates to the addressing of RFID tags by a tag reader.

### BACKGROUND OF THE INVENTION

Various labels have been attached to articles so that the articles can be distinguished one from the other. For example, bar code labels are attached to articles of grocery and are scanned at a check-out counter in order to automatically identify the articles and to register the price of the articles as they are purchased.

Bar code labels have also been used in inventory control and monitoring. Accordingly, these bar codes may be scanned in order to track articles as they move into, through, and out of a storage area. It is also known to read the bar codes attached to articles in order to access various computer records regarding the articles.

Bar code labels, however, have several drawbacks. For example, computer stored records that are accessed when a bar code is read do not move with the corresponding article. Therefore, if the article to which the bar code label is attached is remote from the computer, the records concerning that article cannot be immediately accessed if necessary.

Moreover, bar code labels cannot be read remotely. Thus, if it is desired to take an inventory of articles currently in the storage area, personnel must physically scan each label on each article one at a time in order to determine which articles are presently in the storage area. Such scanning requires the physical presence of the personnel at the location of the articles and is extremely time consuming. Additionally, because bar code labels cannot be read remotely, they cannot be used as security devices that can be detected if the articles to which they are attached are improperly removed from a secured area.

Instead of bar coded labels, it is known to attach radio frequency identification (RFID) tags to the articles to be monitored. As in the case of bar code labels, the RFID tags contain unique identifiers so that the articles to which they are attached can be distinguished from one another. However, unlike bar code labels, reading RFID tags does not require the physical presence of personnel because the RFID tags can instead be read remotely.

Accordingly, inventory can be taken more quickly because personnel are not required to walk around a storage area or other area in order to read the RFID tags. Moreover, because RFID tags can be read remotely, they can be used as security devices. Thus, if someone attempts to surreptitiously remove an article to which an RFID tag is attached from a secured area, a remote reader can sense the RFID tag and provide an appropriate alarm. Furthermore, it is also possible to provide an RFID tag with memory. Therefore, any records concerning the article to which the RFID tag is attached can be maintained on the RFID tag rather than in a remotely located computer.

When reading the IDs and/or other information from RFID tags, a tag reader can address the RFID tags individually, requiring the addressed tag to transmit back reply messages containing the requested information. Alternatively, the tag reader can address all of the tags simultaneously. In this case, all tags will transmit back reply messages containing the desired information. When multiple tags transmit reply messages, there may be a chance of collisions between the reply messages resulting in a loss of information.

A variety of methods have been employed to avoid collisions between the reply messages being transmitted back by the RFID tags to the tag reader. For example, RFID tags have been arranged to randomly select the time slots within which they transmit their reply messages.

It is also useful to interrogate some but not all of the available RFID tags. For example, articles of different types may be stored in one or more storage areas covered by the same tag reader. The articles can be divided into a multiplicity of groups according to a variety of criteria. An example of such a grouping could be by the item type, and each group can be assigned a set of addresses capable of being defined by a unique group address. Thus, when it is desired to take separate inventories of each article type, each group may be individually addressed by its group address and required to respond with appropriate information. The present invention is directed to a technique to perform group addressing so that some but not all RFID tags are required to respond.

### SUMMARY OF THE INVENTION

In accordance with one aspect of the present invention, a method is provided to address a group of RFID tags. The group of RFID tags comprises a subset of a plurality of RFID tags capable of being addressed by a tag reader, and each of the RFID tags in the plurality of RFID tags has a unique identifier. The method comprises the following: inserting a group address into a message, wherein the group address comprises a first set of data elements substantially equal in value to corresponding ones of the data elements in the identifiers of the group of RFID tags, and wherein the group address comprises a second set of data elements representing any value for corresponding ones of the data elements in the identifiers of the group of RFID tags; and, transmitting the message to the plurality of RFID tags.

In accordance with another aspect of the present invention, a method is provided to process a message received from a tag reader. The message contains a group address comprising K data elements, and the group address comprises first and second sets of data elements. The first set of data elements comprises L data elements, the second set of data elements comprises M data elements, and L+M=K, where L≠0, M≠0, and K≠0. The method comprises the following: comparing the group address to an identifier, wherein the identifier comprises K data elements; and, determining a match even if only the first set of data elements favorably compares to corresponding data elements in the identifier.

In accordance with still another aspect of the present invention, a method is provided to process a message from a tag reader. The message contains a group address, and the group address addresses a group of RFID tags. The group of RFID tags comprises a subset of a plurality of RFID tags capable of being addressed by the tag reader, and each of the RFID tags in the plurality of RFID tags has a unique identifier. The group address comprises a first set of data elements that are substantially equal in value to corresponding ones of the data elements in the identifiers of the group of RFID tags. The group address also comprises a second set of data elements that represent any value for corresponding ones of the data elements in the identifiers of the group of RFID tags. The method comprises the following: receiving the message; comparing the group address contained in the received message to one of the identifiers; and, determining a match if each of the first set of data elements favorably compares to a corresponding data element in the one identifier.

### BRIEF DESCRIPTION OF THE DRAWINGS

These and other features and advantages will become more apparent from a detailed consideration of the invention when taken in conjunction with the drawings in which:

FIG. 1 illustrates a tagging system in accordance with one embodiment of the present invention;

FIG. 2 illustrates additional detail a representative one of the tags of the tagging system of FIG. 1;

FIG. 3 illustrates additional detail of a tag reader that can be used with the tagging system of FIG. 1;

FIG. 4 illustrates a message format useful in supporting communications between the tag reader and the tags of the tagging system shown in FIG. 1;

FIG. 5 illustrates an exemplary composition of a frame of the message format shown in FIG. 4;

FIG. 6 illustrates an exemplary composition of the header of the frame shown in FIG. 5;

FIG. 7 illustrates an exemplary composition of a time slot of the frame shown in FIG. 5;

FIG. 8 illustrates an exemplary composition of the header of the time slot shown in FIG. 7;

FIGS. 9 and 10 are flow charts showing an exemplary operation of the tag reader of FIGS. 1 and 3; and,

FIG. 11 is a flow chart showing an exemplary operation of the tags illustrated in FIGS. 1 and 2.

### DETAILED DESCRIPTION

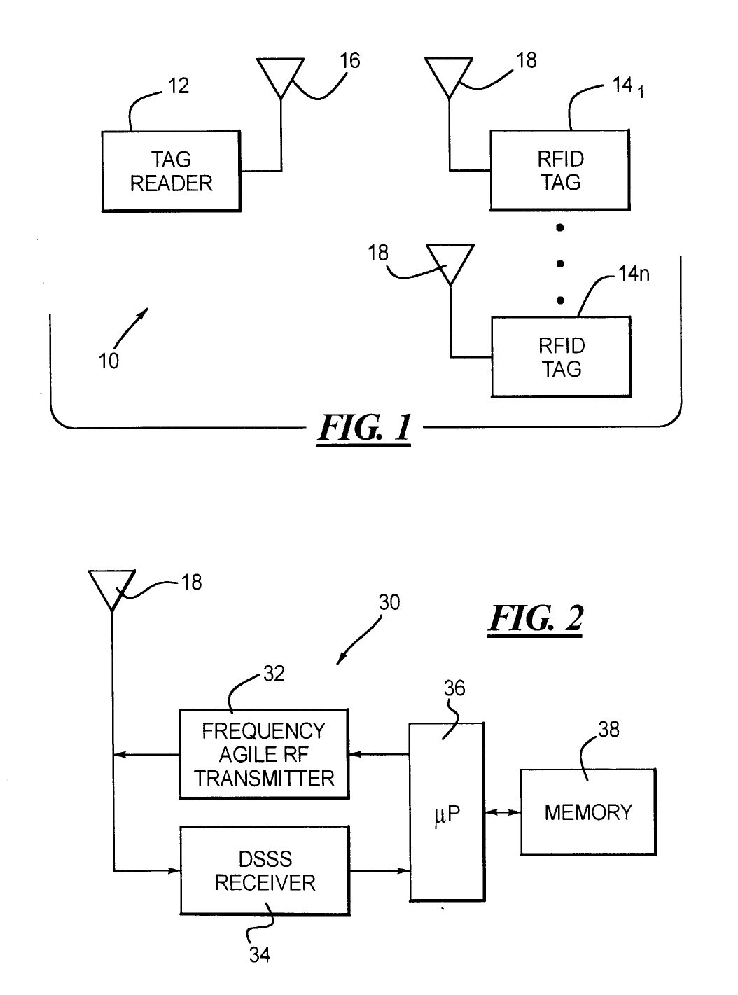

As illustrated in FIG. 1, a tagging system 10 includes a tag reader 12, and a plurality of RFID tags 14₁ through 14ₙ, where n can be any desired number greater than one. The tag reader 12, for example, may be a long range reader capable of reading data from the RFID tags 14₁ through 14ₙ over a substantial distance, such as several hundred feet or more, although the tag reader 12 may have an expected range of anywhere from less than 5 feet up to approximately 500 feet.

The tag reader 12 includes an antenna 16, and each of the RFID tags 14₁ through 14ₙ similarly includes an antenna 18. The antennas 16 and 18 establish an RF link between the tag reader 12 and each of the RFID tags 14₁ through 14ₙ so that the tag reader 12 can remotely read the identifiers and/or other information stored in memories of the RFID tags 14₁ through 14ₙ.

Each of the RFID tags 14₁ through 14ₙ has associated therewith an identifier that uniquely identifies it. The identifier that uniquely identifies each of the RFID tags 14₁ through 14ₙ comprises a plurality of data elements, and a data element can be a bit, a group of bits, a symbol, a group of symbols, etc. Accordingly, each one of the RFID tags 14₁ through 14ₙ can be distinguished from all other ones of the RFID tags 14₁ through 14ₙ by its unique identifier.

If desired, a second reader (not shown), such as a short range reader, may be provided to read data from the RFID tags 14₁ through 14ₙ from only a short distance, such as less than two feet, although the short range reader may be expected, in typical usage, to have a range of between six inches and eighteen inches. A secure link (also not shown) between the second reader and the RFID tags 14₁ through 14ₙ permits the second reader to read information from the RFID tags 14₁ through 14ₙ in a more secure manner. For example, it may not be desirable for the tag reader 12 to read certain information stored in the RFID tags 14₁ through 14ₙ because long range RF communications can be intercepted by a strategically placed surreptitious reader similar to the tag reader 12. Accordingly, the secure link provided by the second reader increases the difficulty in illicitly acquiring the more sensitive information that may be stored on the RFID tags 14₁ through 14ₙ.

This secure link may a hard wire link between the second reader and the RFID tags 14₁ through 14ₙ. Alternatively, the secure link may be a limited range magnetic link such as those provided by contact-free smart cards. As a still further alternative, the secure link may be a limited range RF link. Other alternatives will occur to those skilled in the art. Accordingly, the more sensitive information stored on the RFID tags 14₁ through 14ₙ can be read over the secure link between the second reader and the RFID tags 14₁ through 14ₙ.

One advantage of using a non-hardwired secure link is that then the RFID tags 14₁ through 14ₙ can be more readily used as security devices. Accordingly, when an attempt is made to remove an article to which one of the RFID tags 14₁ through 14ₙ is attached, the second reader located at a portal of a secured area, or otherwise, can elicit and detect a possibly specific signal from the RFID tag indicating that an attempt is being made to remove the article from the secured area.

Each of the RFID tags 14₁ through 14ₙ may have the same architecture. Accordingly, only one of the RFID tags 14₁ through 14ₙ, i.e., the RFID tag 141, is shown in additional detail in FIG. 2. The RFID tag 14₁ includes a transceiver 30 comprising a frequency agile (frequency hopping) RF transmitter 32 and a direct sequence spread spectrum RF receiver 34. The frequency agile RF transmitter 32 and the direct sequence spread spectrum RF receiver 34 are coupled between the antenna 18 and a microprocessor 36. Accordingly, the frequency agile RF transmitter 32 of the RFID tag 14₁ implements frequency hopping in transmitting information to the tag reader 12, and the direct sequence spread spectrum RF receiver 34 of the RFID tag 14₁ implements direct sequence spread spectrum synchronization and decoding in receiving communications from the tag reader 12.

The RFID tag 14₁ may also include a second transceiver (not shown) between the microprocessor 36 and the second reader discussed above. Accordingly, the RFID tag 14₁ can transmit and/or receive communications to and/or from this second reader. In the case where the secure link between the second reader and the RFID tag 14₁ is a hardwire link, the second transceiver may simply be a plug that is connectible to a corresponding plug of the second reader. In the case where the secure link is an RF link, the second transceiver may be an RF transceiver of any known type, provided that this RF transceiver preferably has a shorter range than the frequency agile RF transmitter 32 and the direct sequence spread spectrum RF receiver 34. In the case where the secure link is a magnetic link, the second transceiver may simply be a magnetic emitter (and/or sensor) capable of magnetically interfacing with the second reader.

The RFID tag 14₁ further comprises a memory 38 coupled to the microprocessor 36. The memory 38 stores the unique identifier of the RFID tag 14₁ that can be read by the tag reader 12 through the antennas 16 and 18, the frequency agile RF transmitter 32, the direct sequence spread spectrum RF receiver 34, and the microprocessor 36. The memory 38 may also store other information supplied to it by the second reader through the secure link, the second transceiver, and the microprocessor 36. The memory 38 can additionally store information supplied by the tag reader 12.

In addition to the unique identifier, the information stored in the memory 38 can include, for example, the inventory history of the article to which the RFID tag 14₁ is attached. Accordingly, the date that the article entered inventory, the date that the article left inventory, the length of time that the article has been in inventory, any movement within inventory, and similar information may be stored in the memory 38.

The information stored in the memory 38 may also include shipping manifests that indicate when and to whom the article is to be shipped. Moreover, in the case where individual articles with differing destinations are shipped in the same container, an RFID tag attached to the container, hereafter called a container tag, can be attached to the container. This container tag may be arranged to store the identity and destination of each article in the container. As articles are removed from the container, the information stored in the container tag can be updated to indicate which articles have been removed, the location at which the articles were removed, and the identity of the personnel who removed the articles.

The information stored in the memory 38 may further include maintenance, repair, and date of service records showing the maintenance and/or repair history of the corresponding article.

Other information related to the article may likewise be stored in the memory 38. For example, the integrity of the information stored in the memory 38 can be assured by keeping a record of the modifications to the stored information and of the identity of the personnel making the modifications. As another example, records related to the production of the article may be stored in the memory of the tag.

Accordingly, any information about the article may be stored with the article instead of in a remote computer system or on paper.

Because the records are carried by the RFID tag 14₁ attached to a corresponding article, the RFID tag 14₁ eliminates the need to maintain paper or computer records of the life history of an article, the RFID tag 14₁ eliminates the problem of lost or misplaced records, and the RFID tag 14₁ improves operational efficiency by eliminating the requirement to retrieve records prior to accessing and/or operating on the article.

The RFID tag 14₁ may additionally include a battery (not shown) that is coupled so that it supplies power to the frequency agile RF transmitter 32, to the direct sequence spread spectrum RF receiver 34, to the microprocessor 36, and to the memory 38 (if necessary).

Moreover, a plurality of sensors (not shown) may be coupled to the microprocessor 36. These sensors may include, for example, a temperature sensor, a humidity sensor, and other sensors such as a pressure sensor, a proximity sensor, an electromagnetic sensor, an optical sensor, a mechanical sensor, a chemical sensor, and/or the like. The microprocessor 36 stores the information from the sensors in the memory 38, and this information may be read from the memory 38 by the tag reader 12 (and/or by the second reader).

The microprocessor 36 may be further arranged to sense the voltage level of the battery. Accordingly, the microprocessor 36 stores this voltage level in the memory 38, and this stored voltage level may be read from the memory 38 by the tag reader 12 (and/or by the second reader). Thus, if the voltage level of the battery as read by the tag reader 12 (and/or by the second reader) indicates that the battery needs charging or replacement, suitable remedial action may be taken.

Because of the frequency agile RF transmitter 32 and the direct sequence spread spectrum RF receiver 34, the RFID tag 14₁ is capable of relatively long range activation while providing a low power method for command-response activation by the tag reader 12. This long range activation allows the RFID tag 14₁ to be placed at distances remote from the tag reader 12 for purposes of interrogating the RFID tag 14₁ for its unique identifier and possibly other information.

The frequency agile RF transmitter 32 and the direct sequence spread spectrum RF receiver 34 allow the tagging system 10 to operate in the FCC defined Industrial Scientific and Medical (ISM) bands at maximum legal power. Both frequency hopping as used by the frequency agile RF transmitter 32 and direct sequence spread spectrum communications as used by the direct sequence spread spectrum RF receiver 34 circumvent jamming by narrow-band signals using different methods of spreading the signal over a large bandwidth. The direct sequence spread spectrum RF receiver 34 can receive signals from the tag reader 12 within milliseconds of activation. By contrast, a frequency agile receiver must search a long frequency hopping sequence in order to receive signals from the tag reader 12. The time required to make this search is typically longer than the time required to detect a direct spread spectrum sequence because the direct spread spectrum signal is either on a fixed frequency or on one of only a few frequencies.

An embodiment of the tag reader 12 is shown in additional detail in FIG. 3. The tag reader 12 includes a direct sequence spread spectrum RF transmitter 50 and a frequency agile RF receiver 52 coupled between the antenna 16 and a microprocessor 54. The frequency agile RF receiver 52 of the tag reader 12 implements frequency hopping in receiving information from the frequency agile RF transmitter 32 of the RFID tags 14₁ through 14ₙ. Moreover, the direct sequence spread spectrum transmitter 50 of the tag reader 12 implements direct sequence spread spectrum transmission in transmitting communications to the direct sequence spread spectrum RF receiver 34 of the RFID tags 14₁ through 14_{n.}

The tag reader 12 further comprises a memory 56 coupled to the microprocessor 54. The memory 56 stores the information that the tag reader 12 receives from the RFID tags 14₁ through 14ₙ. The memory 56 also stores the software that supports a communication protocol as described herein.

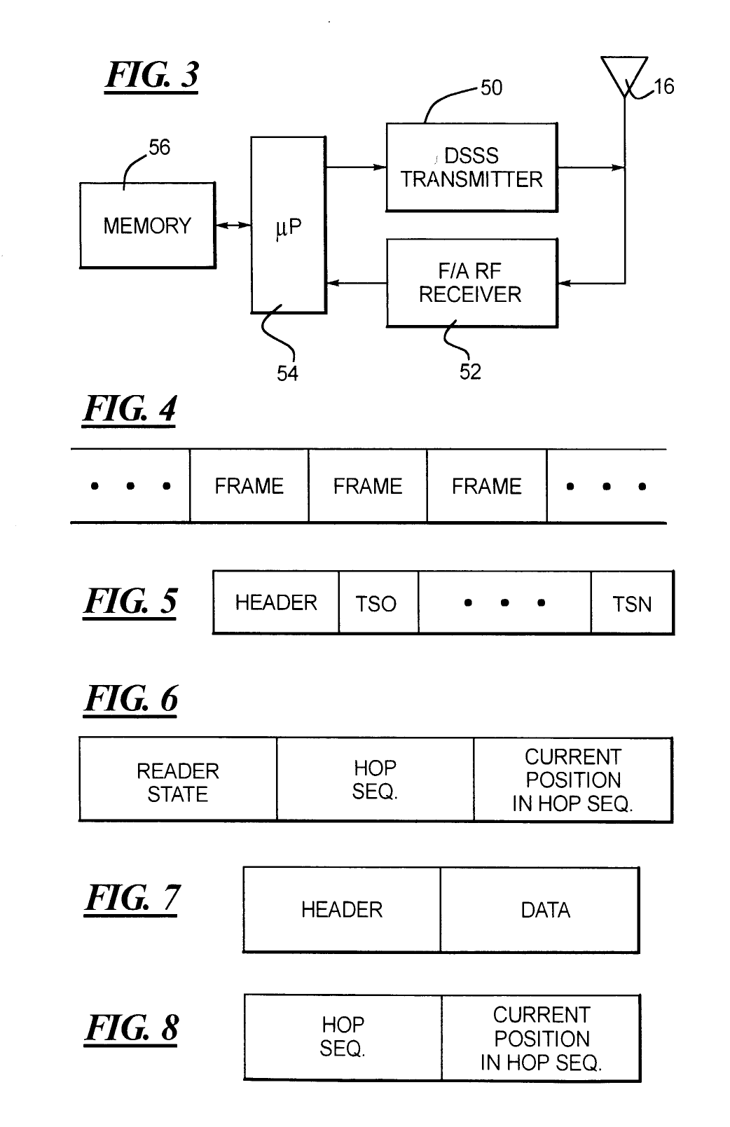

This communication protocol governs the message format that is used between the tag reader 12 and the RFID tags 14₁ through 14ₙ. According to one embodiment of the communication protocol that governs the message format that is used between the tag reader 12 and the RFID tags 14₁ through 14ₙ, a message may be comprised of a plurality of frames as shown in FIG. 4. Each frame is preferably no longer than the length of time that the frequency agile RF transmitter 32 is allowed to dwell at any given frequency.

Each of the frames shown in FIG. 4 has the construction shown in FIG. 5. Accordingly, each frame has a frame header and a number of time slots TS0-TSN. The frame header contains information about the tag reader 12 that is reading the RFID tags 14₁ through 14ₙ. As shown in FIG. 6, the header contains (i) the state of the tag reader 12, (ii) the hop sequence currently being used by the tag reader 12 to receive messages from the RFID tags 14₁ through 14ₙ, and (iii) the current position (i.e., frequency) of the tag reader 12 in this hop sequence. The frame header can also contain such other information as may be useful in the tagging system 10. For example, the frame header may also contain the number (N+1) of the time slots in the corresponding frame, an individual address of a specific one of the RFID tags 14₁ through 14ₙ, and/or a group address of a subset of the RFID tags 14₁ through 14ₙ.

The tag reader 12 may have several reader states including, for example, an active communication state and a beacon state. In the active communication state, the tag reader 12 commands responses from one or more of the RFID tags 14₁ through 14ₙ. In the beacon state, the RFID tags 14₁ through 14ₙ self-initiate the transmission of messages to the tag reader 12.

The hop sequence and/or the current position in the hop sequence as contained in the frame header are/is useful to tags that have limited signal processing capability. Such tags, for example, may have no capability themselves to determine the frequency (i.e., the current position in the hop sequence) onto which they should transmit their responses.

Moreover, each time slot may also include a time slot header and data portion as shown in FIG. 7, and each time slot header, as shown in FIG. 8, may contain the hop sequence and the current position in the hop sequence of the tag reader 12. The time slot header may also contain the relative position, such as a time slot number (0, 1, . . . , or N), of the corresponding time slot in the frame. This relative position information may be used by the RFID tags 14₁ through 14ₙ to establish a relative timing interval into which the RFID tags 14₁ through 14ₙ can transmit data. By transmitting the hop sequence and the current position in the hop sequence at the beginning of each time slot, the RFID tags 14₁ through 14ₙ are aided in their rapid acquisition of the current hop sequence and frequency. Because the RFID tags 14₁ through 14ₙ can acquire, from the header in each time slot, sufficient information about the frequency and timing of the tag reader 12, the RFID tags 14₁ through 14ₙ may power down until such time that they expect the complete header information to be transmitted by the tag reader 12. Therefore, the RFID tags 14₁ through 14ₙ are able to substantially reduce the amount of power that they use to determine the frequency and timing to be used by their frequency agile RF transmitter 32 in transmitting information in the data portion of the time slot.

As indicated above, the tag reader 12 transmits all headers, whether frame headers or time slot headers. The RFID tags 14₁ through 14ₙ transmit only in the data portion of the time slots. Each of the RFID tags 14₁ through 14ₙ may implement a non-deterministic method of selecting a time slot for the transmission of its data. By using a non-deterministic method of selecting a time slot, the possibility of a plurality of tags transmitting data into the same time slot is minimized. For purposes of illustration, such a non-deterministic method of selecting a time slot could be embodied by a pseudo-random number generator that pseudo-randomly generates the number of a time slot into which its corresponding tag transmits its data. This implementation results in a communications protocol similar to, but not identical to, the Aloha protocol, a standard communications protocol.

Alternatively, the RFID tags 14₁ through 14ₙ may transmit in a time slot determined by their identifiers stored in the memory 38. For example, if there are more tags than there are time slots in a single frame, the more significant data elements in the identifiers assigned to the RFID tags 14₁ through 14ₙ may be used to designate a frame, and the less significant data elements in the identifier assigned to the RFID tags 14₁ through 14ₙ may be used to designate a time slot in the frame designated by the more significant data elements.

Accordingly, the RFID tags 14₁ through 14ₙ of the tagging system 10 should transmit their information to the tag reader 12 in a way than minimizes the likelihood of contention. If more than one of the RFID tags 14₁ through 14ₙ should transmit in the same time slot, the tag reader 12 can command the non-contending ones of the RFID tags 14₁ through 14ₙ to be silent and command only the contending tags (or a reduced number of tags that includes the contending tags) to respond to the next interrogation from the tag reader 12.

The tag reader 12 can communicate directly with a specific tag or a group of specific tags. When the tag reader 12 is communicating directly with a specific tag or a group of specific tags, the tag reader 12 may suspend the transmission of time slot headers. This suspension indicates to all other tags that their communications are to be suspended. Also, all data may be transmitted between the tag reader 12 and the RFID tags 14₁ through 14ₙ in packets having packet numbers so that both the tag reader 12 and the RFID tags 14₁ through 14ₙ can detect missing or duplicate data. Moreover, acknowledgements can be used to signify a successful transmission between the tag reader 12 and the RFID tags 14₁ through 14ₙ. A failure to receive an acknowledgement can cause re-transmission of the information. Once a transaction between the tag reader 12 and either a specific one of the RFID tags 14₁ through 14ₙ or a group of the RFID tags 14₁ through 14ₙ is complete, the tag reader 12 resumes transmitting the headers.

The tag reader 12 can read the RFID tags 14₁ through 14ₙ by selective activation and/or deactivation of the RFID tags 14₁ through 14ₙ by groups. A group of the RFID tags 14₁ through 14ₙ can be interrogated by requiring only those of the RFID tags 14₁ through 14ₙ having identifiers matching a bit pattern transmitted by the tag reader 12 to respond.

For example, the tag reader 12 may transmit a header of a signal including (i) an indication that the signal is an interrogation signal, (ii) an indication that the signal contains a group address, and (iii) the group address. For purposes of this example, it is assumed that each of the RFID tags 14₁ through 14ₙ has a twelve bit identifier, and if it is assumed that the group address is 1110001110xxx, where 0 is a zero bit in a tag identifier, 1 is a one bit in a tag identifier, and x means a bit in the tag identifier of any value (frequently referred to as a “don't care” bit), then all of the RFID tags 14₁ through 14ₙ having 111000110 for the first nine bits of their identifiers will respond to the interrogation signal.

As an other example, if it is assumed that the group address is 01000xxx1101, where again 0 is a zero bit in a tag identifier, 1 is a one bit in a tag identifier, and x means a bit in the tag identifier of any value, then all of the RFID tags 14₁ through 14ₙ having 01000 for the first five bits and 1101 for the last four bits of their identifiers will respond to the interrogation signal.

Although the x's (“don't care” bits) in the above examples are shown as being grouped together in a group address, they instead may be scattered throughout the group address such that, using the assumed twelve bit identifier discussed above, the group address may be 0x11x010xx11, for example.

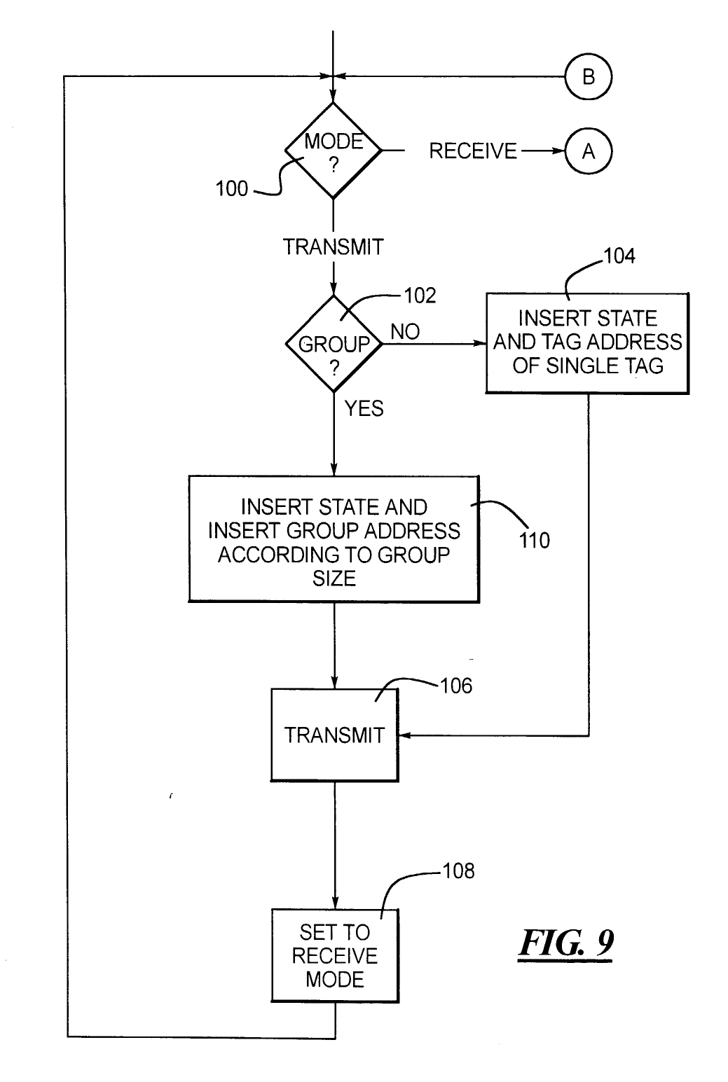

As shown in FIG. 9, when the tag reader 12 is in the transmit mode (block 100), and if the tag reader 12 determines at a block 102 that just one of the RFID tags 14₁ through 14ₙ is to be addressed, the tag reader 12 at a block 104 inserts the state of tag reader (the active communication state and a single tag is being addressed) and the address (identifier) of the addressed one of the RFID tags 14₁ through 14ₙ into a header. The tag reader 12 then transmits the header (block 106) and sets its mode to the receive mode (block 108).

However, when the tag reader 12 is in the transmit mode (block 100), and if the tag reader 12 determines at the block 102 that a group of the RFID tags 14₁ through 14ₙ is to be addressed, the tag reader 12 at a block 110 inserts the state of tag reader (the active communication state and that a group of tags is being addressed) and the group address (an identifier with designated data element positions set to x) of the addressed group of the RFID tags 14₁ through 14ₙ into a header. The tag reader 12 then transmits the header (block 106) and sets its mode to the receive mode (block 108).

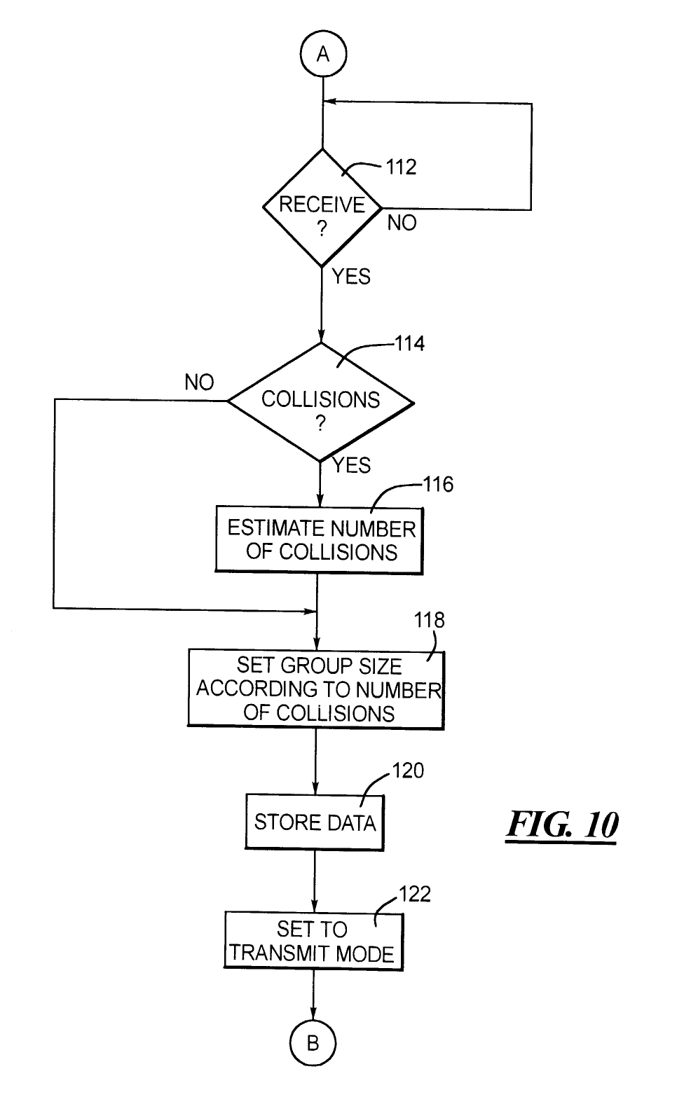

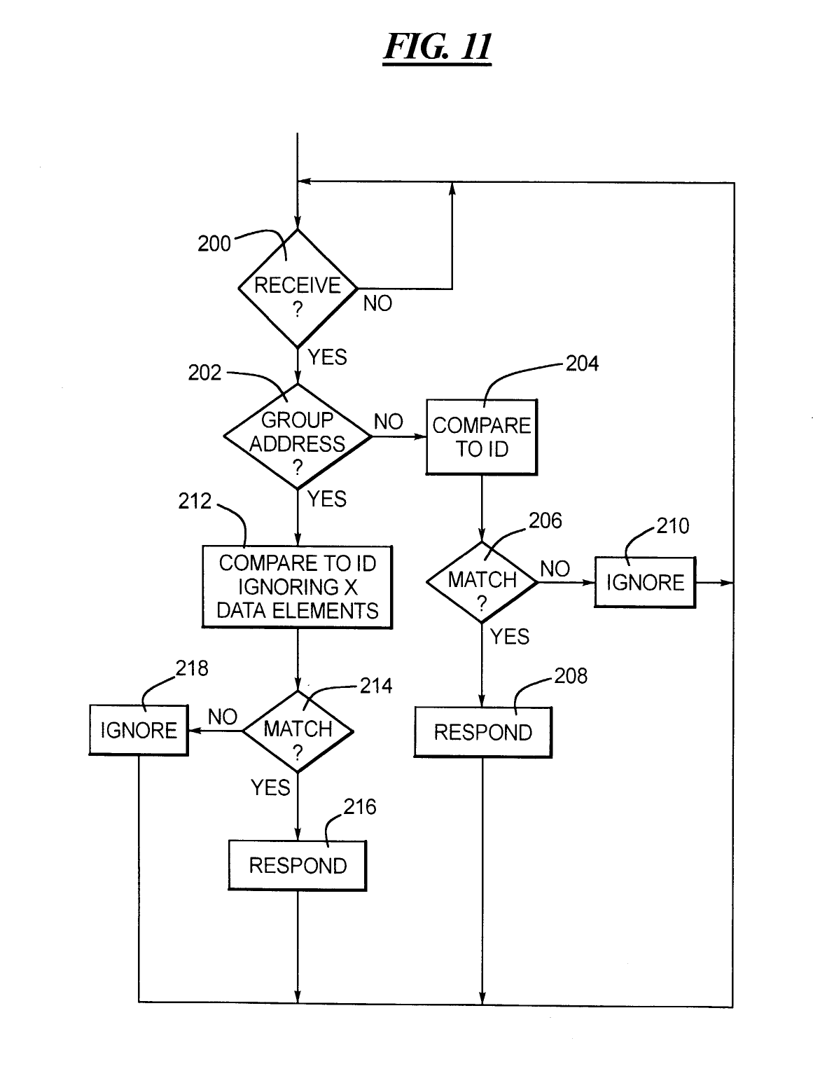

When the tag reader 12 is in the receive mode (block 100), it waits to receive a reply message from one or more of the RFID tags 14₁ through 14ₙ (FIG. 10; block 112). When the tag reader 12 receives a reply message, it determines whether there were any collisions between tag replies (block 114). If the tag reader 12 determines that contention occurred between two or more tags, the is tag reader 12 estimates the number of collisions that took place (block 116) and sets the group size for a group address in accordance with the number of colliding tags (block 118). On the other hand, if the tag reader 12 detects no collisions at the block 114, and in fact determines that the reply message (such as one or more time slots) is empty, the tag reader at the block 118 likewise adjusts the group size accordingly.

The tag reader 12 at the block 118 sets the group size with the objective of filling up the time slots of a frame while at the same time minimizing or eliminating contention between the addressed RFID tags. Accordingly, when there are empty time slots in the return frame, the tag reader 12 at the block 118 increases the group size so that, when the next group address is transmitted, the time slots will be more efficiently utilized. A larger group address may be implemented, for example, by increasing the number of x's in the group address.

On the other hand, when collisions have occurred in the received message, the tag reader 12 at the block 118 decreases the group size so that, when the next group address is transmitted, collisions in the reply message are reduced or are avoided altogether. A smaller group address may be implemented, for example, by decreasing the number of x's in the group address.

The tag reader 12 can adjust the size of the group address without estimating the number of collisions at the block 116. For example, the tag reader 12 may be arranged to eliminate an x from the group address one at a time until a reply message free of colliding data is received. However, it is more efficient to estimate the number of collisions in a reply message so that the tag reader can more quickly reach a steady state where all time slots contain data and there are no empty time slots. Accordingly, the tag reader 12 will converge on the optimum utilization of time slots more efficiently. In determining the number of collisions, the tag reader 12 may use any known method. One method of estimating the number of collisions is for the reader 12 to count the number of time slots in which a signal is present at or above a predetermined signal strength at which correct reception is greater than 99% probable yet the signal in the time slot cannot be correctly decoded. This implies that the signal has been corrupted and the most likely source of corruption is a collision between two or more tag transmissions. For example, if a simple majority of the time slots are determined to be occupied yet corrupted, the likelihood of a similar result from repeating the interrogation unchanged is quite high. In such a case, a reduction in group size would be in order. A determination of which “don't care” bits in the group address to remove can be made by examining the commonality of the messages that were successfully received vis-á-vis the group address and selecting one of the “don't care” address bits that are not common to the addresses received, as these bits are more likely to be present in more tags and, hence, result in more transmitting devices and consequently more message collisions. Other methods may be obvious to those skilled in the art.

In the setting of the group size, the tag reader 12 may wait for the reception of plural time slots.

Such an arrangement is advantageous particularly in tagging systems having a large and changing number of tags. The tag reader 12 thus periodically determines the identifiers of the RFID tags 14₁ through 14ₙ that are in the tagging system 10 and uses this information in setting group addresses of the appropriate size. The tag reader 12 can implement artificial intelligence in determining optimum grouping based on the estimated number of collisions in a reply message and the addresses present in those messages may be used to determine group addresses.

After the group size in set, the tag reader 12 at a block 120 stores any data not involved in collisions in the memory 38 and sets itself to the receive mode at a block 122. On the other hand, if there were no collisions as determined at the block 114, the tag reader 12 at the block 120 stores all data in the reply message, and sets itself to the receive mode at the block 122.

As shown in FIG. 11, when the RFID tags 14₁ through 14ₙ receive a message (block 200), the RFID tags 14₁ through 14ₙ determine whether the message contains a group address (202). If the RFID tags 14₁ through 14ₙ determine that the message contains an individual address, the RFID tags 14₁ through 14ₙ compare the individual address to their own identifiers on a data element-by-data element basis (block 204). A match requires that each data element in a tag's identifier compare favorably with the corresponding data element in the received individual address.

If a tag determines that all data elements of its identifier compare favorably with all of the corresponding data elements in the individual address of the received message (block 206), that tag responds appropriately at a block 208. This response may involve (i) transmitting back to the tag reader 12 the identifier of the tag, and/or (ii) transmitting back to the tag reader 12 any or all data stored in the memory 38, and/or (iii) taking such other action as the received message requires.

If a tag determines that at least one of data elements of its identifier does not compare favorably with a corresponding one of the data elements contained in the individual address of the received message (block 206), that tag ignores the received message (block 210).

On the other hand, if the RFID tags 14₁ through 14ₙ determine that the received message contains a group address (block 202), the RFID tags 14₁ through 14ₙ compare the group address to their own identifiers on a data element-by-data element basis (block 212). In making the comparison at the block 212, however, a match is required only between the non-x, or non-“don't care” data elements of the group address contained in the received message and the corresponding data elements in the identifiers of the RFID tags 14₁ through 14ₙ. Thus, a match requires that each data element in the received individual address, except for the x data element positions, compare favorably with a corresponding data element in a tag's identifier.

For example, if the non-x, or non-“don't care” data elements of the group address comprise a first set of data elements of the group address, and if the x data elements of the group address comprise a second set of data elements of the group address, then a match requires a favorable comparison between only the first set of data elements in the group address and the corresponding data elements in the identifiers.

Those tags, which determine that all non-x, or non-“don't care” data elements of the group address compare favorably with the corresponding data elements in their identifiers, respond appropriately at a block 216. As before, these responses may involve (i) transmitting back to the tag reader 12 the identifiers of the matching tags, and/or (ii) transmitting back to the tag reader 12 any or all data stored in their memories 38, and/or (iii) taking such other actions as the received message requires.

Those tags, which determine that at least one of the non-x, or non-“don't care” data elements of the received group address does not compare favorably with a corresponding one of the data elements of their identifiers, ignore the received message (block 210).

In responding to the received message, the RFID tags 14₁ through 14ₙ may select a corresponding time slot on any desired basis. For example, the responding tags may choose a time slot on a pseudorandom basis, or they may choose a time slot on the basis of all or a portion of their identifiers. In any event, once the tags have either responded to or ignored the received message, the tags wait for the next message.

Certain modifications of the present invention have been disclosed above. Other modifications will occur to those practicing in the art of the present invention. For example, although the RFID tags 14₁ through 14ₙ are shown as microprocessor based tags in FIG. 2, each of the RFID tags 14₁ through 14ₙ may instead comprise one or more digital circuit elements, and/or one or more programmable logic-arrays, and/or one or more dedicated integrated circuits, etc.

Also, the tag reader 12 as described above has a range of several hundred feet and could have an expected range of approximately 500 feet. However, this range could be longer or shorter depending on the application and/or other factors. Similarly, the range given above for the second reader could be other than as described above.

Additionally, the transmitter of the transceiver 30 of the RFID tags 14₁ through 14ₙ is described above as the frequency agile RF transmitter 32, and the receiver of the transceiver 30 of the RFID tags 14₁ through 14ₙ is described above as the direct sequence spread spectrum RF receiver 34. However, the RFID tags 14₁ through 14ₙ may instead advantageously use other types of transmitters and receivers.

Moreover, the tagging system 10 may include only one tag reader or more than one tag reader. Indeed the tagging system 10 may include any number of tag readers. Similarly, the RFID tags 14₁ through 14ₙ need only include one transceiver, or the RFID tags 14₁ through 14ₙ may include more than one transceiver. Indeed, each of the RFID tags 14₁ through 14ₙ may include any number of transceivers.

Furthermore, as described above, the tags that are addressed respond to a received message. Alternatively, the addressed tags may instead enter a quiescent or silent state such that it is the non-addressed tags which respond to the received message.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of addressing a group of RFID tags, wherein the group of RFID tags comprises a subset of a plurality of RFID tags capable of being addressed by a tag reader, wherein each of the RFID tags in the plurality of RFID tags has a unique identifier, and wherein the method comprises:
inserting a group address into a message, wherein the group address comprises a first set of data elements substantially equal in value to corresponding ones of the data elements in the identifiers of the group of RFID tags, and wherein the group address comprises a second set of data elements representing any value for corresponding ones of the data elements in the identifiers of the group of RFID tags; and,
transmitting the message to the plurality of RFID tags.

2. The method of claim 1 wherein each of the identifiers comprises K data elements, wherein the first set of data elements comprises L data elements, wherein the second set of data elements comprises M data elements, and wherein L+M=K.

3. The method of claim 1 further comprising:
receiving reply messages;
increasing a size of the group address if no reply messages collided; and,
decreasing the size of the group address if at least some of the reply messages collided.

4. The method of claim 1 wherein the first set of data elements comprises L data elements, wherein the second set of data elements comprises M data elements, and wherein the inserting of a group address into a message comprises inversely adjusting L and M depending upon replies received in response to the message.

5. The method of claim 4 wherein each of the identifiers comprises K data elements, and wherein L+M=K.

6. The method of claim 1 further comprising:
receiving reply messages;
estimating a number of the reply messages that collide; and,
determining a size for the group address in accordance with the estimated number.

7. The method of claim 6 wherein the first set of data elements comprises L data elements, wherein the second set of data elements comprises M data elements, and wherein the inserting of a group address into a message comprises inversely adjusting L and M in accordance with the determined size.

8. The method of claim 7 wherein each of the identifiers comprises K data elements, and wherein L+M=K.

9. The method of claim 6 wherein the determining of a size for a group address comprises increasing the group size when the number of colliding reply messages decreases and decreasing the group size when the number of colliding reply messages increases.

10. The method of claim 1 wherein the message comprises a first message, wherein the method further comprises transmitting a second message to the plurality of RFID tags, and wherein the second message contains an address of a specific one of the plurality of RFID tags.

11. The method of claim 10 wherein each of the identifiers comprises K data elements, wherein the address of a specific one of the plurality of RFID tags comprises L data elements, and wherein L=K.

12. The method of claim 1 further comprising receiving reply messages and storing data contained in the reply messages.

13. The method of claim 1 further comprising:
receiving data in time slots;
increasing a size of the group address if at least one of the time slots contains no data; and,
decreasing the size of the group address if at least some of the time slots contain collided data.

14. A method of processing a message received from a tag reader, wherein the message contains a group address comprising K data elements, wherein the group address comprises first and second sets of data elements, wherein the first set of data elements comprises L data elements, wherein the second set of data elements comprises M data elements, wherein L+M=K, wherein L≠0, wherein M≠0, wherein K≠0, and wherein the method comprises:
comparing the group address to an identifier, wherein the identifier comprises K data elements; and,
determining a match even if only the first set of data elements favorably compares to corresponding data elements in the identifier.

15. The method of claim 14 wherein the comparing of the group address to an identifier comprises comparing only the first set of data elements in the group address to corresponding data elements in the identifier.

16. The method of claim 14 further comprising transmitting a reply message only if the match is determined.

17. The method of claim 14 wherein the message comprises a first message, wherein the group address comprises a first address, wherein the match comprises a first match, and wherein the method further comprises:
receiving a second message, wherein the second message contains a second address, wherein the second address contains N data elements, and wherein N=K;
comparing the second address to the identifier; and, determining a second match only if all of the N data elements of the second address favorably compare to corresponding data elements in the identifier.

18. The method of claim 17 further comprising transmitting a first reply message only if the first match is determined and transmitting a second reply message only if the second match is determined.

19. A method of processing a message from a tag reader, wherein the message contains a group address, wherein the group address addresses a group of RFID tags, wherein the group of RFID tags comprises a subset of a plurality of RFID tags capable of being addressed by the tag reader, wherein each of the RFID tags in the plurality of RFID tags has a unique identifier, wherein the group address comprises a first set of data elements substantially equal in value to corresponding ones of the data elements in the identifiers of the group of RFID tags, wherein the group address comprises a second set of data elements representing any value for corresponding ones of the data elements in the identifiers of the group of RFID tags, and wherein the method comprises:
receiving the message;
comparing the group address contained in the received message to one of the identifiers; and,
determining a match if each of the first set of data elements favorably compares to a corresponding data element in the one identifier.

20. The method of claim 19 further comprising transmitting a reply message only if the match is determined.

21. The method of claim 19 wherein each of the identifiers comprises K data elements, wherein the first set of data elements comprises L data elements, wherein the second set of data elements comprises M data elements, and wherein L+M=K.

22. The method of claim 19 wherein the message comprises a first message, wherein the group address comprises a first address, wherein the match comprises a first match, and wherein the method further comprises:
receiving a second message, wherein the second message contains a second address of a specific one of the plurality of RFID tags;
comparing the second address to one of the identifiers; and,
determining a second match only if all data elements of the second address favorably compares to corresponding data elements in the one identifier.

23. The method of claim 22 further comprising transmitting a first reply message only if the first match is determined and transmitting a second reply message only if the second match is determined.

24. The method of claim 22 wherein each of the identifiers comprises K data elements, wherein the second address comprises N data elements, and wherein N=K.

25. The method of claim 22 wherein each of the identifiers comprises K data elements, wherein the first set of data elements comprises L data elements, wherein the second set of data elements comprises M data elements, and wherein L+M=K.

26. The method of claim 25 wherein the second address comprises N data elements, and wherein N=K.

27. The method of claim 19 wherein the received message comprises a first received message, wherein the group address comprises a first group address, wherein the method further comprises receiving second and third messages containing second and third respective group addresses, wherein the second group address covers a larger group of RFID tags than the group of RFID tags covered by the first group address as a result of fewer collisions in a previous reply message, and wherein the third group address covers a smaller group of RFID tags than the group of RFID tags covered by the first group address as a result of more collisions in a previous reply message
